(19) United States
(12) Patent Application Publication
(10) Pub. No.: US 2024/0155071 A1
(43) Pub. Date: May 9, 2024

(54) TEXT TO VIDEO GENERATION

(71) Applicant: Meta Platforms Technologies, LLC, Menlo Park, CA (US)

(72) Inventors: Sonal Gupta, Sunnyvale, CA (US); Adam Polyak, Tel Aviv (IL); Thomas Falstad Hayes, San Francisco, CA (US); Xi Yin, Mountain View, CA (US); Jie An, Rochester, NY (US); Chao Yang, Jersey City, NJ (US); Oron Ashual, Tel Aviv (IL); Oran Gafni, Ramat Gan (IL); Devi Niru Parikh, San Francisco, CA (US); Yaniv Nechemia Taigman, Raanana (IL); Uriel Singer, Harish (IL); Songyang Zhang, Rochester, NY (US); Qiyuan Hu, Mountain View, CA (US)

(21) Appl. No.: 18/477,887

(22) Filed: Sep. 29, 2023

Related U.S. Application Data
(60) Provisional application No. 63/411,530, filed on Sep. 29, 2022.

(51) Int. Cl. H04N 7/01; G06T 11/00

(52) U.S. Cl. CPC H04N 7/0117; G06T 11/00; H04N 7/013; H04N 7/0135

(57) ABSTRACT

A method and system for text-to-video generation. The method includes receiving a text input, generating a representation frame based on the text input using a model trained on text-image pairs, generating a set of frames based on the representation frame and a first frame rate, interpolating the set of frames to a higher frame rate, generating a first video based on the interpolated set of frames, increasing a resolution of the first video based on a first and second super-resolution model, and generating an output video based on a result of the super-resolution models.

### BACKGROUND

### Field

The present disclosure is generally related to an adaptive artificial intelligence (AI) text-video generation model that leverages text-to-image generation and motion learning. More specifically, the present disclosure includes generating video from text using a spatial-temporal pipeline without requiring paired text-video data.

### Related Art

Recently, large-scale generative networks have been applied for generating images from text based on image generation frameworks trained on large-scale paired text-image datasets. Similarly, text-video generation frameworks may be trained on paired text-video datasets. However, text-video lags behind largely due to the lack of large-scale datasets with high-quality text-video pairs, and the complexity of modeling higher-dimensional video data. As a result, standard video generation is focused on simple domains and are trained on smaller (or private) text-video pairs. As such, a more accessible, adaptable, and accelerated video generation model is desirable.

### SUMMARY

The subject disclosure provides for systems and methods for text-to-video generation. In one aspect of the present disclosure, the method includes receiving a text input, generating a representation frame based on text embeddings of the text input, generating a set of frames based on the representation frame and a first frame rate, interpolating the set of frames based on a second frame rate, generating a first video based on the interpolated set of frames, increasing a resolution of the first video based on spatiotemporal information to generate a second video, and generating an output video by increasing a resolution of the second video based on spatial information.

Another aspect of the present disclosure relates to a system configured for text-to-video generation. The system includes one or more processors, and a memory storing instructions which, when executed by the one or more processors, cause the system to perform operations. The operations include to receive a text input, generate a representation frame based on text embeddings of the text input, generate a set of frames based on the representation frame and a first frame rate, interpolate the set of frames based on a second frame rate, generate a first video based on the interpolated set of frames, increase a resolution of the first video based on spatiotemporal information using a first super-resolution model to generate a second video, and generate an output video by increasing a resolution of the second video based on spatial information using a second super-resolution model.

Yet another aspect of the present disclosure relates to a non-transient computer-readable storage medium having instructions embodied thereon, the instructions being executable by one or more processors to perform a method(s) for text-to-video generation. The instructions causing the one or more processors to receive a text input, generate a representation frame based on text embeddings of the text input, decoding a set of frames conditioned on the representation frame and a frame rate, interpolate the set of frames based on a second frame rate, generate a first video based on the interpolated set of frames, increase a resolution of the first video based on spatiotemporal information using a first super-resolution model to generate a second video, and increase a resolution of the second video based on spatial information using a second super-resolution model to generate an output video.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a diagram of an environment in which methods, apparatuses and systems described herein may be implemented, according to some embodiments.

FIG. 2 is a block diagram illustrating details of devices used in the architecture of FIG. 1, according to some embodiments.

FIG. 3 is a block diagram illustrating a text-video generation framework of a text-video generation model used to generate a video based on a text input without requiring paired text-video data, according to some embodiments.

FIG. 4 illustrates an architecture of pseudo-3D convolutional layers, according to one or more embodiments.

FIG. 5 illustrates an architecture and initialization scheme of pseudo-3D attention layers, according to some embodiments.

FIG. 6 illustrates an example block diagram of a system for text-to-video generation, according to some embodiments.

FIG. 7 illustrates a flowchart of a method for text-to-video generation, according to some embodiments.

FIG. 8 is a block diagram illustrating a computer system used to at least partially carry out one or more of operations in methods disclosed herein, according to some embodiments.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Recently, large-scale generative networks have been applied for generating images from text based on image generation frameworks trained on large-scale paired text-image datasets. Similarly, text-video generation frameworks may be trained on paired text-video datasets. However, replicating the success of text-image for videos is largely limited due to the lack of similarly sized (text, video) large-scale datasets with high-quality text-video pairs, and the complexity of modeling higher-dimensional video data. The limited text-video datasets also cause misalignment between user text inputs and generated videos. As a result, standard video generation is focused on simple domains and are trained on smaller (or private) text-video pairs, such as moving digits or specific human actions. Additionally, training a text-video model from scratch would significantly increase cost of the framework and would be an insufficient use of resources when there already exist models that can generate images. As such, a more accessible, adaptable, and accelerated video generation model, which leverages text-image datasets to reduce cost of the model, is desirable.

Embodiments of this disclosure describe a text-video generation framework that leverages open-source datasets used in text-image generation and unsupervised learning, enabling networks to learn from orders of magnitude more data, to generate video from text. According to embodiments, a text-video generation model of the framework learns the correspondence between text and the visual world from paired text-image data and uses unsupervised learning on unlabeled (unpaired) video data to learn realistic motion. The text-video generation model is pretrained on images and fine-tuned on videos. The large quantity of text-image data is important to learn representations of more subtle, less common concepts in the world. Models pre-trained this way yield considerably higher performance than when solely trained in a supervised manner. The text-video generation framework, according to embodiments, breaks the dependency on text-video pairs for text-video generation. This is a significant advantage as the output of the text-video generation is not restricted to narrow domains or does not require large-scale paired text-video data. By fine-tuning over unlabeled video data, the text-video generation of embodiments gains the advantage of adapting the text-image model weights effectively, compared to, for example, freezing the weights. Further, the use of pseudo-3D convolution and temporal attention layers not only better leverages a text-image architecture, but it also allows for improved temporal information fusion.

According to aspects of embodiments, the text-video generation framework extends spatial layers at the model initialization stage, using function-preserving transformations, to include temporal information. The extended spatial-temporal network includes new attention modules that learn temporal world dynamics from a collection of videos. This procedure significantly accelerates the text-video training process by instantaneously transferring the knowledge from a previously trained text-image network to a new text-video network.

Text-image networks include convolutional layers and attention layers. Attention layers self-attend to extracted features and may inject text information to several network hierarchies, alongside other relevant information, such as the diffusion time-step. Using 3D convolutional layers is computationally heavy and adding temporal dimension to attention layers would result in even more memory consumption. To address this, embodiments extend dimension decomposition to attention layers by stacking spatial attention and temporal attention layers.

In some embodiments, the text-video generation model decomposes a full temporal U-Net and attention tensors and approximates them in space and time. The spatial-temporal pipeline is used to generate high resolution and frame rate videos with a video decoder, frame interpolation model and super-resolution models. According to embodiments, the super-resolution models and frame interpolation models are trained to enhance visual quality of the generated video. This increases the resolution of the generated videos, as well as enables a higher (controllable) frame rate, generating high-definition, high frame-rate videos given a textual input.

Although embodiments are described with reference to video generation, systems and methods consistent with those described herein may be implemented for other tasks such as, but not limited to, image animation, video variation, etc.

Embodiments as disclosed herein provide a solution rooted in computer technology and arising in the realm of text-video generation, namely generating videos from text without leveraging paired text-video data. The disclosed subject technology further provides improvements to the functioning of the computer itself because it accelerates training of the text-video model (as it does not need to learn visual and multimodal representations from scratch). Further, the text-video model does not require paired text-video data. This allows the computer to use less compute resources and training time, ultimately reducing cost, and accordingly, improving the technological field of text-video generation as well as user experience by producing quality spatial-temporal resolution videos that are faithful to text inputs, while increasing efficiency. Further, text-video generation models/methods according to embodiments also advantageously inherit the vastness (diversity in aesthetic, fantastical depictions, etc.) of image generation models.

### Example Architecture

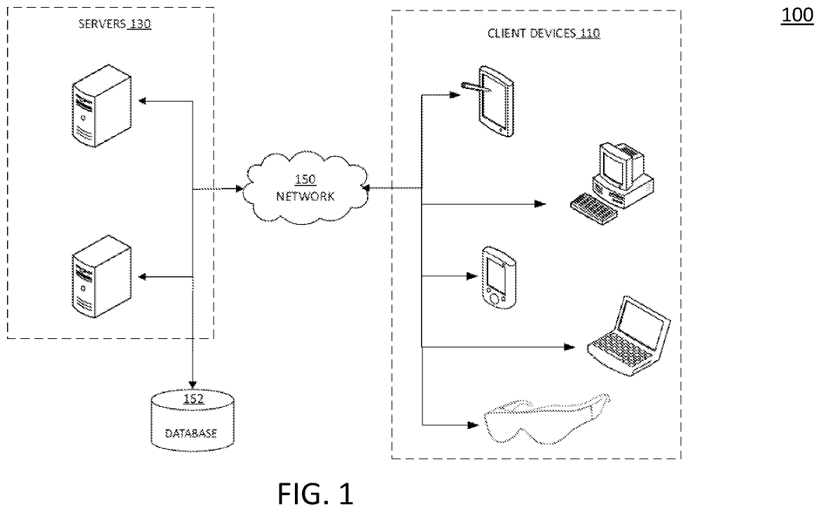

FIG. 1 illustrates a network architecture 100 used to implement text-video generation, according to some embodiments. Architecture 100 may include servers 130 and a database 152, communicatively coupled with multiple client devices 110 via a network 150. Any one of servers 130 may host a platform/application running on client devices 110, used by one or more of the participants in the network. Servers 130 may include a cloud server or a group of cloud servers. In some implementations, servers 130 may not be cloud-based (i.e., platforms/applications may be implemented outside of a cloud computing environment) or may be partially cloud-based. Client devices 110 may include any one of a laptop computer, a desktop computer, or a mobile device such as a smart phone, a palm device, video player, or a tablet device. In some embodiments, client devices 110 may include a headset or other wearable device (e.g., a virtual reality or augmented reality headset or smart glass). The database 152 may store backup files from the platform, including generated videos and inputs.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

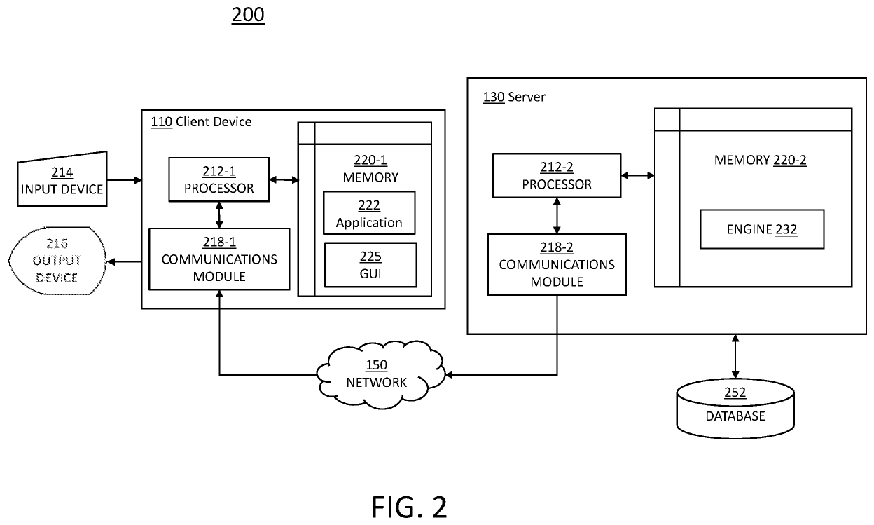

FIG. 2 is a block diagram 200 illustrating details of a client device 110 and servers 130 used in a network architecture as disclosed herein (e.g., architecture 100), according to some embodiments. Client device 110 and servers 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units—IMUs—and other sensors configured to provide input data to a VR/AR headset. Output device 216 may be a screen display, a touchscreen, a speaker, and the like.

Client device 110 may also include a processor 212-1, configured to execute instructions stored in a memory 220-1, and to cause client device 110 to perform at least some operations in methods consistent with the present disclosure. Memory 220-1 may further include an application 222 and a GUI 225, configured to run in client device 110 and couple with input device 214 and output device 216. The application 222 may be downloaded by the user from servers 130 and may be hosted by servers 130. The application 222 includes specific instructions which, when executed by processor 212-1, cause operations to be performed according to methods described herein. In some embodiments, the application 222 runs on an operating system (OS) installed in client device 110. In some embodiments, application 222 may run out of a web browser. In some embodiments, the processor is configured to control a graphical user interface (GUI) for the user of one of client devices 110 accessing the server of the social platform.

The application 222 may include one or more modules configured to perform operations according to aspects of embodiments. Such modules are later described in detail.

A database(s) 252 may store data and files associated with the social platform from the application 222. In some embodiments, client device 110 is a mobile phone used to collect a video or picture and upload to servers 130 using a video or image collection application 222, to store in the database(s) 252.

Servers 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an engine 232. The engine 232 may share or provide features and resources to GUI 225, including multiple tools associated with text, image or video collection, capture, or design applications that use images or pictures retrieved with engine 232 (e.g., application 222). The user may access engine 232 through application 222, installed in a memory 220-1 of client device 110. Accordingly, application 222, including GUI 225, may be installed by servers 130 and perform scripts and other routines provided by servers 130 through any one of multiple tools. Execution of application 222 may be controlled by processor 212-1. Servers 130 may include an application programming interface (API) layer, which controls applications in the client device 110. API layer may also provide tutorials to users of the client device 110 as to new features in the application 222.

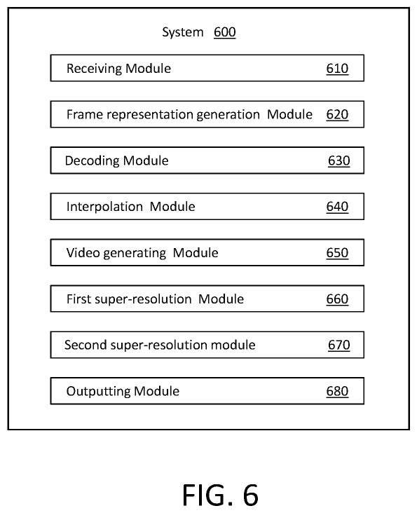

Engine 232 may include one or more modules (e.g., modules later described with reference to system 600 in FIG. 6) configured to perform operations according to one or more aspects of embodiments described herein. The engine 232 includes a neural network tool which may be part of one or more machine learning models stored in the database(s) 252. The database(s) 252 includes training archives and other data files that may be used by engine 232 in the training of a machine learning model, according to the input of the user through application 222.

In some embodiments, at least one or more training archives or machine learning models may be stored in either one of memories 220 or the user may have access to them through application 222. The neural network tool may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), an unsupervised learning algorithm, a deep recurrent neural network (DRNN), a classic machine learning algorithm such as random forest, diffusion based text-image models, or any combination thereof. More generally, the machine learning model may include any machine learning model involving a training step and an optimization step. In some embodiments, the database(s) 252 may include a training archive to modify coefficients according to a desired outcome of the machine learning model. Accordingly, in some embodiments, engine 232 is configured to access database(s) 252 to retrieve documents and archives as inputs for the machine learning model. In some embodiments, engine 232, the tools contained therein, and at least part of database(s) 252 may be hosted in a different server that is accessible by servers 130 or client device 110.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

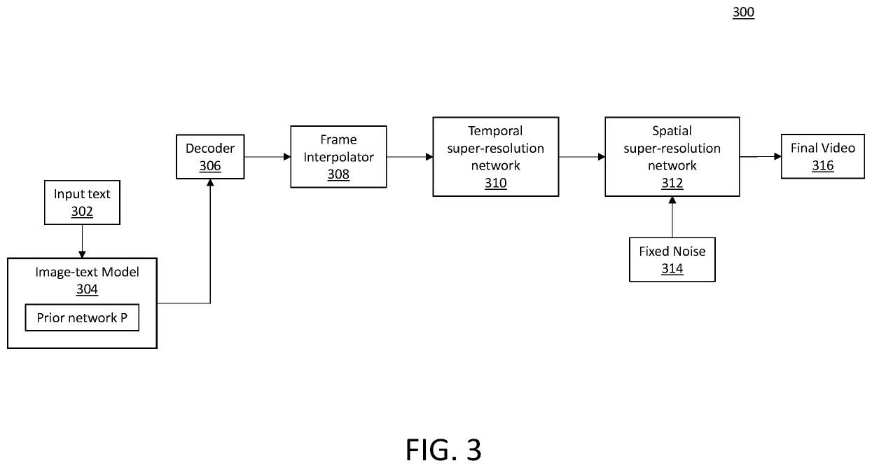

FIG. 3 is a block diagram illustrating a text-video generation framework 300 of a text-video generation model used to generate a video based on a text input without requiring paired text-video data, according to one or more embodiments.

According to embodiments, the framework 300 may include three main components: (i) a base text-image model trained on text-image pairs, (ii) spatiotemporal convolution and attention layers that extend the networks' building blocks to the temporal dimension, and (iii) spatiotemporal super-resolution networks that consist of both spatiotemporal layers, as well as a frame interpolation network for high frame rate generation. This creates a seamless transition from static to temporal visuals. In some implementations, the base text-image model is a diffusion-based text-image model which the framework 300 extends to text-video generation through a spatiotemporally factorized diffusion model. The framework 300 leverages joint text-image priors to bypass the need for paired text-video data, which in turn allows scaling of the model to larger quantities of video data. The spatiotemporal super-resolutions approximated in space and time enable the generation of high-definition, high frame-rate videos given a textual input.

Prior to the addition of temporal components, the base text-image model is trained on text-image pair datasets. During inference, a prior network P of the text-image model 304 is configured to generate image embeddings given text embeddings based on an input text 302 and encoded (e.g., byte pair encoded) text tokens. The prior network P is the only component in the framework trained on paired text-image data. The inference scheme of the framework 300 may be formulated as:

[symbol]

=SRₕ∘SRₗ^{t}∘↑F∘D^{t}∘P∘(\hat{x}, Cₓ(x)) Equation 1

Where [symbol] is the generated video, SRₕ is a spatial super-resolution network, SRₗ^{t} is a spatiotemporal super-resolution network, ↑F is a frame interpolation network (i.e., implemented by frame interpolator 308), Dt is the spatiotemporal decoder (i.e., decoder 306), P is the prior network, \hat{x} is the BPE-encoded text token, Cₓ is a CLIP text encoder, and x is a input text.

Given an input text 302, the text-image model 304 may include encoding the input text 302 using a pre-trained text encoder to generate the text embedding. The text-image model 304 then translates the input text 302 by prior network P into the image embedding.

The decoder 306 generates a set of frames that make up a low-resolution video based on a desired frame rate fₚₛ and the image embedding. During training, the decoder 306 is first trained on images and then extended to the temporal dimension by adding a spatiotemporal layer. The decoder 306 is further fine-tuned on video data that is not labeled or annotated. The frame rate fₚₛ is a conditioning parameter representing the number of frames-per-second in the low-resolution video. By non-limiting example, the set of frames may include 16 64×64 frames. In some implementations, the set of frames may comprise of low-resolution 64×64 RGB images conditioned on the image embedding.

According to embodiments, the text-video generation model is optimized by minimizing the hybrid loss to train the decoder 306. In some implementations, the loss function consists of two terms: a simple loss that learns to predict added noise and a loss L_{vlb} that adds a constraint on an estimated variational lower bound (VLB). The loss term [symbol] _{decoder} that predicts the added noise, according to embodiments, is defined as:

[symbol]

_{decoder}= [symbol] _{C}_{_{y}}_{(y}_{₀}_{),ϵ,f}_{ₚₛ}_{,t}[∥ϵₜ−ϵ_{θ}(zₜ, C_{y}(y₀), fₚₛ, t)∥₂² Equation 2

where y is an input video (e.g., the low-resolution video) and y₀ represents a first frame of the video. C_{y}(y₀) denotes the extracted CLIP image embedding of the first frame. zₜ is the noisy input added to y at time step t that is uniformly sampled from 1 to T during training. fₚₛ is the frame rate embedding as described above. ϵₜ is the added noise that is to be estimated by the network represented as ϵ_{θ}.

The frame interpolator 308 interpolates the set of frames to a higher frame rate generating a first video based on an interpolation model. The interpolation model may generate the frames of the first video considering the frame rate fₚₛ and image embeddings from the prior network P. Increasing the frame rate before applying spatiotemporal considerations helps to increase the quality of the final generated video. During training, the frame interpolator 308 is fine-tuned from the spatiotemporal decoder 306 based on random masking of different frames. During inference, frame interpolator 308 applies the interpolation is performed using a sliding window.

According to embodiments, the interpolation model may complete the task of interpolation using image representations of two images. By non-limiting example, the interpolation model may take the two images as the beginning and end frames and masks 14 frames in between for generation based on their image representations. As mentioned, because the frame interpolator 308 is fine-tuned from the spatiotemporal decoder 306, the frame interpolator 308 is able to generate more semantically meaningful interpolation frames (in contrast to merely providing a smooth transition between frames without semantic real-world understanding of what is moving). In some implementations, the frame interpolator 308 takes the average CLIP embedding of all frames from a video as the condition to generate a semantically similar video.

According to some embodiments, an extrapolation model may be applied similar to the interpolation model of the frame interpolator 308. For example, extrapolation model may be configured to take the first 4 frames of the set of frames and extend them into 16 frames. This may be repeatedly performed for subsequent groups of 4 frames in the set of frames. The interpolation model, according to embodiments, may be constrained and conditioned to perform interpolation based on specific frames in specific components and/or positions of frames in the set of frames. For example, assuming the set of frames includes 16 frames, frames with the first, last, and middle positions may be considered the references frames for the interpolation. The reference frames are then used to generate the rest of the frames that makeup the first video. Following the same example, the interpolation results in a 76 frame, 64×64 resolution video. Constraining the interpolation model in this way enables the frame interpolator 308 to effectively and efficiently learn how to extrapolate, interpolate between frames and infer actions/events from static images.

The spatiotemporal super-resolution network 310 is a first upsampler that increases the resolution of the frames in the first video based on a spatiotemporal super-resolution model. The spatiotemporal super-resolution network 310 is trained on image data and fine-tuned on unlabeled video data, thus improves the video resolution by considering temporal information. Following the same example above, the spatiotemporal super-resolution network 310 may increase the resolution of the 76×64×64 first video to generate a second video with 256×256 resolution (i.e., 76×256×256). According to embodiments, spatiotemporal super-resolution network 310 collectively upscales the resolution the first video to a higher resolution. Improving the resolution of the video helps boost the final video quality significantly.

The spatial super-resolution network 312 is a second upsampler that increases the resolution of the frames in the second video, based on a spatial super-resolution model, to generate a final video 316. Following the same example above, the spatial super-resolution network 312 may increase the resolution of the 76×256×256 second video to generate a final high-spatiotemporal-resolution video of 76×768×768 resolution video. The spatial super-resolution model applies a fixed noise 314 to each of the frames in the second video to help reduce artifacts in the final video. The second super-resolution model may be applied independently on each frame with the same sampled frame noise (e.g., fixed noise 314).

According to embodiments, the frame-video portions of the text-video generation framework 300 (e.g., frame interpolator 308 and super-resolution networks 310/312) are trained on video datasets to learn motion and adapt spatiotemporal consistency throughout the generated video (i.e., final video 316). Training the model on unlabeled video data enables training on significantly larger datasets with higher quality videos, which in turn improves accuracy and alignment of the generated video to the text input.

In some embodiments, the final generated frames of the final video 316 are downsampled to (e.g., to 512) using bicubic interpolation to provide a cleaner visual of the frames in the video. In some implementations, the super-resolution networks involve hallucinating information. In order to prevent flickering artifacts, the hallucinations must be consistent across frames. As a result, the super-resolution networks operate across spatial and temporal dimensions, which outperform per-frame super resolution. In some embodiments, the spatial super-resolution network operates only along the spatial dimensions. However, to encourage consistent detail hallucination across frames, a same noise initialization is used for each frame.

According to embodiments, in order to expand the two-dimensional (2D) conditional network used in text-image generation (e.g., the text-image model) into the temporal dimension (i.e., 3D) for video generation, convolutional layers and attention layers of a super-resolution model are modified to handle both spatial and temporal dimensions in order to generate videos. Other layers, such as fully-connected layers, do not require specific handling when adding an additional dimension, as they are agnostic to structured spatial and temporal information. Temporal modifications include, for example, the decoder 306 generating 16 RGB frames, each of size 64×64, the frame interpolator 308 increasing the effective frame rate by interpolating between the generated set of frames, and the spatiotemporal super-resolution network including added temporal layers. According to embodiments, the temporal layers are added to the spatiotemporal super-resolution model when fine-tuning on videos.

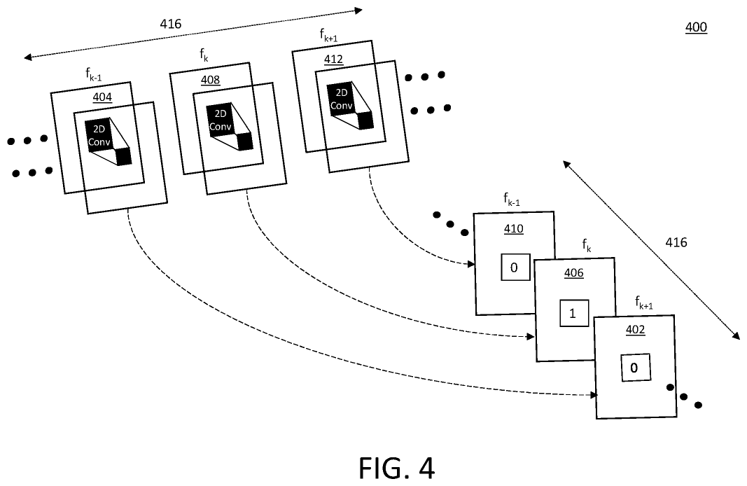

FIG. 4 illustrates an architecture of pseudo-3D convolutional layers 400 of a spatiotemporal super-resolution network, according to one or more embodiments.

According to embodiments, each spatial 2D convolutional layer is followed by a temporal 1D convolution layer. As shown in FIG. 4, a first 1D conv (fₖ₊₁) 402 is stacked on a first 2D conv (fₖ₋₁) 404 in a temporal dimension 416. Similarly, a second 1D conv (fₖ) 406 is stacked on a second 2D conv (fₖ) 408, and a third 1D conv (fₖ₋₁) 410 is stacked on a third 2D conv (fₖ₊₁) 412 in the temporal dimension 416. Stacking a 1D convolution layer following each 2D convolutional layer and factorizing based on time facilitates information sharing between the spatial and temporal axes, without succumbing to the heavy computational load of 3D convolutional layers. In addition, it creates a concrete partition between the pre-trained 2D convolutional layers and the newly initialized 1D convolutional layers, enabling training of the temporal convolutions from scratch, while retaining the previously learned spatial knowledge in the spatial convolutions' weights.

Given an input tensor h ∈ [symbol] ^{B×C×F×H×W}, where B, C, F, H, W are the batch, channels, frames, height, and width dimensions, respectively, the pseudo-3D convolutional layer (Conv_{P3D}) is defined as:

Conv_{P3D}(h):=Conv_{1D}(Conv_{2D}(h)∘T)∘T Equation 3

where the transpose operator ∘T swaps between the spatial and temporal dimensions. For smooth initialization, while the 2D convolutional layer (Conv_{2D}) is initialized from the pre-trained text-image model, the 1D convolutional layer (Conv_{1D}) is initialized as the identity function, enabling a seamless transition from training spatial-only layers to spatiotemporal layers. The initialization of the new temporal layers is important in order not to destruct the weights of the pre-trained text-image model. At initialization, the text-video generation model will generate K different images (due to random noise), each faithful to the input text but lacking temporal coherence. Moreover, the set of frames (generated at decoder 306) will have spatial consistency obtained from the text-image model, however, will likely lack the temporal consistency needed for a video. Therefore, for each upsampled frame, the text-video model must learn how to fix the upsampling and create temporal consistent upsampling.

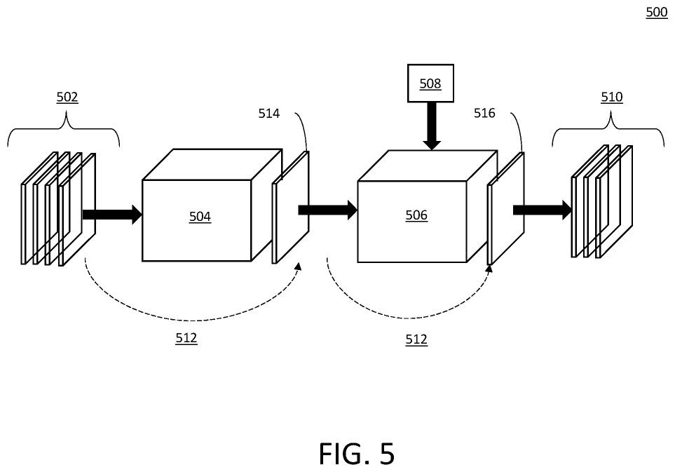

FIG. 5 illustrates an architecture and initialization scheme 500 of pseudo-3D attention layers of spatiotemporal super-resolution network, according to one or more embodiments. The pseudo-3D convolutional and pseudo-3D attention layers enable the seamless transition of a pre-trained text-to-image model to the temporal dimension. According to embodiments, temporal convolutional layers and temporal attention layers are initialized with an identity function.

Temporal attention layers are applied following the spatial attention layers by initializing the temporal projection to zero, resulting in an identity function of the temporal attention blocks. A temporal attention layer is stacked following each (pre-trained) spatial attention layer, which as with the convolutional layers, approximates a full spatiotemporal attention layer.

A previous residual layer output 502 is input to the spatial attention layers 504. The spatial attention layers 504 may include embedded image tokens. Output of a frame positional encoder 508 and projection 514 of the spatial attention layers 504 is applied to the temporal attention layers 506. The temporal attention layers 506 may include embedded image tokens per frame. As described above, a projection 516 of the temporal attention layers 506 are initialized at zero (i.e., k₀=0) and the next residual layer input 510 is generated based on the projection. In some embodiments, the initialization scheme 500 may include skip connections 512 in the spatial-temporal network.

Given an input tensor h, a matrix operator flattens the spatial dimension into h′ ∈ R^{B×C×F×HW}. The inverse matrix operator is used to unflatten the spatial dimension. The pseudo-3D attention layer ATTN_{P3D} is therefore, according to some embodiments, defined as:

ATTN_{P3D}(h)=unflatten(ATTN_{1D}(ATTN_{2D}(flatten(h))∘T)∘T) Equation 3

As similarly described with the pseudo-3D convolutional layer, to allow for smooth spatiotemporal initialization, the pseudo-3D attention layer ATTN_{P3D} is initialized from the pre-trained text-image model and the 1D attention layer ATTN_{1D} is initialized as the identity function. According to embodiments, temporal and spatial layers are trained jointly, and an additional 3×1×1 convolution projection (after each 1×3×3) is applied such that the temporal information will also be passed through each convolution layer.

According to some embodiments, the text-video generation model is conditioned on the text-image model and the frame rate fₚₛ. Conditioning on a varying number of frames-per-second enables an additional augmentation method to tackle the limited volume of available videos at training time, and provides additional control on the generated video at inference time.

In addition to the spatiotemporal modifications (presented by the spatiotemporal model), aspects of embodiments include training a new masked frame interpolation (and extrapolation) network ↑F capable of increasing the number of frames of the generated video. In some implementations, the number of frames of the generated video are increased by frame interpolation, resulting in a smoother generated video. In some implementations, the number of frames of the generated video are increased by pre/post frame extrapolation for extending the video length. In order to increase the frame rate within memory and compute constraints, the spatiotemporal decoder 306 is finetuned on the task of masked frame interpolation, by zero-padding the masked input frames, enabling video upsampling.

When fine-tuning on masked frame interpolation, an additional 4 channels may be added to the input of the U-Net. For example, the additional channels may include 3 channels for the RGB masked video input and an additional binary channel indicating which frames are masked. Variable frame-skips (e.g., skip connections 512) and the frame rates fₚₛ are conditioned to enable multiple temporal upsample rates at inference time. The training objective of the frame interpolator 308, similar to training the decoder 306, is to minimize the hybrid loss with the additional condition of the unmasked frames. The frame interpolation network ↑F expands the given video tensor through masked frame interpolation. By non-limiting example, a frame interpolation (and extrapolation) network ↑F with a frame skip of 5 may be applied to up sample a 16-frame video to 76 frames (i.e., (16−1)×5+1). According to embodiments, the same architecture and processes of interpolation described may be applied for video extrapolation and/or image animation by masking frames at the beginning or end of a video.

In some embodiments, the text-video generation model may be used for image animation where the masked frame interpolation and extrapolation network ↑F is conditioned on an input image and CLIP image embedding to extrapolate the rest of the video. This allows a user to generate a video using their own image giving the user the opportunity to personalize and directly control the generated video.

The different models described as part of the text-video generation model/framework may be trained independently (e.g., the text-image model, interpolation model, and super-resolution models) and applied during inference. The only component that receives text as input is the prior network P of the text-image model which is trained on paired text-image data. According to embodiments, the prior network P is not fine-tune it on videos. According to embodiments, the decoder (i.e., decoder 306) and two super-resolution models are first trained on images alone (without aligned text). As described, the decoder 306 receives CLIP image embedding as input, and the super-resolution networks 310/312 receive downsampled images as input during training. After training on images, new temporal layers are added to the second super-resolution model. The new temporal layers are initialized and fine-tune over unlabeled video data. In some implementations, 16 frames are sampled from the original video with random fₚₛ within a set range (e.g., from 1 to 30). The beta function is used for sampling and while training the decoder, images are sampled starting from higher fₚₛ ranges (i.e., less motion) and then transition to lower fₚₛ ranges (i.e., more motion). The masked-frame-interpolation component may be fine-tuned from the temporal decoder.

According to embodiments, as described with reference to FIGS. 3-5, the text-video generation model includes several components (e.g., text-image model, interpolator, super-resolution networks). In some implementations, a subset of the model components may be used while any one or more of the model components are excluded. By non-limiting example, the text-video generation model may implement the super-resolution models (without prior interpolation). Other variations of the text-video generation model are understood to be in scope of the present disclosure.

Embodiments described provide advantages over other systems including, but not limited to, providing an effective method that extends a diffusion-based text-image model to text-video through a spatiotemporally factorized diffusion model, leveraging joint text-image priors to bypass the need for paired text-video data, which in turn allows scaling to larger quantities of video data, and providing super-resolution strategies in space and time that generate high-definition, high frame-rate videos given a user-provided textual input. Further, systems and methods according to embodiments generate state-of-the-art results in quantitative as well as qualitative measures, achieving enhanced zero-shot performance in both video quality and text-video faithfulness, improved generalization capabilities that generate more coherent video. Methods in accordance with embodiments can advantageously excels when there are large differences between frames where having real-world knowledge of how objects move is crucial.

FIG. 6 illustrates an example block diagram of a system 600 for text-to-video generation, according to one or more embodiments. The apparatus 600 may include computing platform(s) which may be configured by machine-readable instructions. Machine-readable instructions may include one or more instruction modules. The instruction modules may include computer program modules. As shown in FIG. 6, the instruction modules may include one or more of a receiving module 510, determining module 520, concatenating module 530, mapping module 540, and generating module 550, and/or other instruction modules.

In some implementations, one or more of the modules 610, 620, 630, 640, 650, 660, 670, and 680 may be included in the client device 110 (e.g., in the application 222) and performed by one or more processors (e.g., processor 212-1). In some implementations, one or more of the modules 610, 620, 630, 640, 650, 660, 670, and 680 may be included in the server 130 (e.g., in the engine 232) and performed by one or more processors (e.g., processor 212-2). In some implementations, one or more of the modules 610, 620, 630, 640, 650, 660, 670, and 680 are included in and performed by a combination of the client device and the server.

The receiving module 610 is configured to receive a text input at a user device (e.g., client device 110).

The frame representation generation module 620 is configured to generate a representation frame or image embedding based the text input. The representation frame is generated using a text-to-image model trained on text-image pair datasets. The text-to-image generation model may further include encoding the text input, extracting a text embedding from the text input, and generating the image embedding based on the text embedding.

The decoding module 630 is configured to generate a set of frames based on the representation frame and a first frame rate. The first frame rate may be predefined by the system. The set of frames may be combined to generate a low-resolution video.

The interpolation module 640 is configured to interpolate the set of frames to a second frame rate. The second frame rate is greater frame rate than the first frame rate. As such, frames of the low-resolution video are interpolated to a higher frame rate. In some implementations, the system 600 includes extrapolating frames to predict future frames given several specified frames.

The system 600 may further include, interpolating/extrapolating frames based on the set of frames by identifying a preset number of frames and/or frame positions (e.g., three frames being a first frame, middle frame, and last frame) from the set of frames, and generating additional intermediate or future frames (e.g., intermediate frames between each of the first, middle, and last frames) using an interpolation model, according to embodiments.

The video generating module 650 is configured to generate a first video with an increased frame rate based on the interpolated set of frames.

The first super-resolution module 660 is configured to increase the resolution of the first video to a first resolution value considering spatiotemporal information based on a spatiotemporal super-resolution model. According to embodiments, the spatiotemporal super-resolution model is trained on image datasets and fine-tuned on unlabeled video data. The spatiotemporal super-resolution model generates a second video with higher resolution. The resolution of the first video may be collectively increased to the higher resolution.

According to embodiments, the spatiotemporal super-resolution model includes spatiotemporal convolution and attention layers. The system 600 may further include stacking a temporal convolution layer on each spatial convolution layer, and a temporal attention layer on each spatial attention layer. The system 600 may even further include initializing a temporal projection of the temporal attention layer to zero and initializing the temporal convolution layer with an identity function.

The second super-resolution module 670 is configured to increase the resolution of the second video to a second resolution value considering spatial information based on a spatial super-resolution model. The spatial super-resolution model is trained on image datasets. The resolution of the second video is increased on a frame-by-frame basis and applies a fixed noise to each of the frames in the second video. A high-spatiotemporal-resolution video is generated based on the results of the spatial super-resolution model.

The outputting module 680 is configured output the high-spatiotemporal-resolution video to the client device and/or output to, for example, a display of the client device.

Although FIG. 6 shows example blocks of the system 600, in some implementations, the system 600 may include additional blocks, fewer blocks, different blocks, or differently arranged blocks than those depicted in FIG. 6. Additionally, or alternatively, two or more of the blocks of the system may be combined.

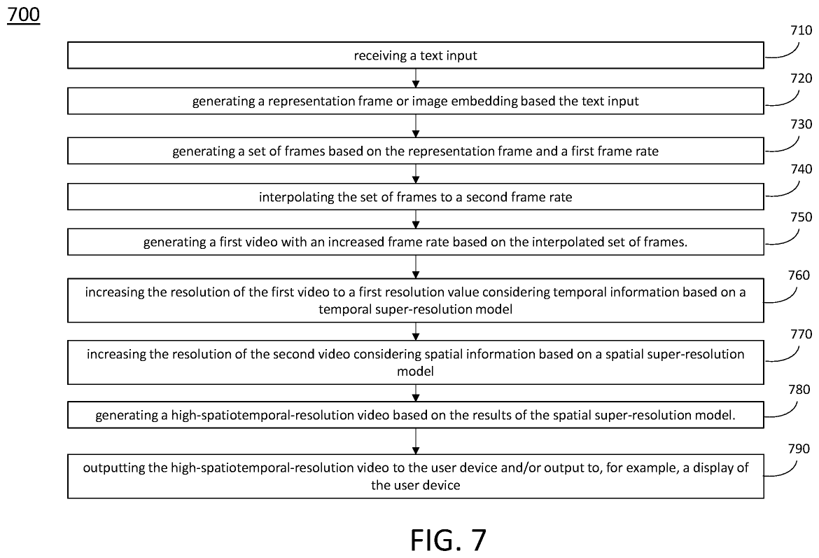

FIG. 7 is a flowchart of a method 700 for text-to-video generation, according to one or more embodiments.

In some embodiments, one or more of the operations/steps in method 700 may be performed by one or more of the modules 610, 620, 630, 640, 650, 660, 670, and 680. In some implementations, one or more operation blocks of FIG. 7 may be performed by a processor circuit executing instructions stored in a memory circuit, in a client device, a remote server or a database, communicatively coupled through a network. In some embodiments, methods consistent with the present disclosure may include at least one or more operations as in method 700 performed in a different order, simultaneously, quasi-simultaneously or overlapping in time.

As shown in FIG. 7, at operation 710, the method 700 includes receiving a text input at a user device.

At operation 720, the method 700 includes generating a representation frame or image embedding based the text input.

At operation 730, the method 700 includes generating a set of frames based on the representation frame and a first frame rate.

At operation 740, the method 700 includes interpolating the set of frames to a second frame rate. In some implementations, the method 700 may further include extrapolating frames to predict future frames given several specified frames. The method 700 may further include extrapolating frames based on the set of frames by identifying a preset number of frames and/or frame positions (e.g., first frame, middle frame, and last frame) from the set of frames, and generating additional intermediate or future frames (e.g., intermediate frames between the first, middle, and last frames) using an interpolation model. The method 700 may even further include generating future frames by extending the set of frames based on a subset of the set of frames (e.g., the first 4 frames are extended to 16 frames).

At operation 750, the method 700 includes generating a first video with an increased frame rate based on the interpolated set of frames.

At operation 760, the method 700 includes increasing the resolution of the first video to a first resolution value considering spatiotemporal information based on a spatiotemporal super-resolution model. The spatiotemporal super-resolution model is trained on image data and fine-tuned on unlabeled video data. The spatiotemporal super-resolution model generates a second video with higher resolution. The resolution of the first video is collectively increased.

At operation 770, the method 700 includes increasing the resolution of the second video to a second resolution value considering spatial information based on a spatial super-resolution model. The spatial super-resolution model is trained on image datasets. The resolution of the second video is increased on a frame-by-frame basis and applies a fixed noise to each of the frames in the second video.

At operation 780, the method 700 includes generating a high-spatiotemporal-resolution video based on the results of the spatial super-resolution model.

At operation 790, the method 700 includes outputting the high-spatiotemporal-resolution video to the user device and/or output to, for example, a display of the user device.

According to embodiments, the spatiotemporal super-resolution model and the spatial super-resolution model are fine-tuned over unlabeled video data.

According to embodiments, the spatiotemporal super-resolution model includes spatiotemporal convolution and attention layers. The method 700 may further include stacking a temporal convolution layer on each spatial convolution layer, and a temporal attention layer on each spatial attention layer. The method 700 may even further include initializing a temporal projection of the temporal attention layer to zero and initializing the temporal convolution layer with an identity function.

Although FIG. 7 shows example blocks of the method 700, in some implementations, the method 700 may include additional blocks, fewer blocks, different blocks, or differently arranged blocks than those depicted in FIG. 7. Additionally, or alternatively, two or more of the blocks of the method may be performed in parallel.

### Hardware Overview

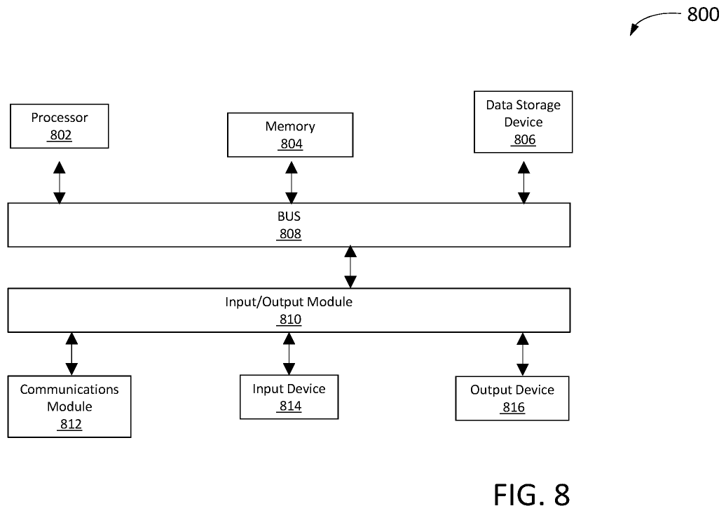

FIG. 8 is a block diagram illustrating an exemplary computer system 800 with which the client and server of FIGS. 1 and 2, and method 7000 can be implemented. In certain aspects, the computer system 800 may be implemented using hardware or a combination of software and hardware, either in a dedicated server, or integrated into another entity, or distributed across multiple entities. Computer system 800 may include a desktop computer, a laptop computer, a tablet, a phablet, a smartphone, a feature phone, a server computer, or otherwise. A server computer may be located remotely in a data center or be stored locally.

Computer system 800 (e.g., client 110 and server 130) includes a bus 808 or other communication mechanism for communicating information, and a processor 802 (e.g., processors 212) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804 (e.g., memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, e.g., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 (e.g., communications modules 218) include networking interface cards, such as Ethernet cards and modems. In certain aspects, input/output module 810 is configured to connect to a plurality of devices, such as an input device 814 (e.g., input device 214) and/or an output device 816 (e.g., output device 216). Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 816 include display devices, such as an LCD (liquid crystal display) monitor, for displaying information to the user.

According to one aspect of the present disclosure, the client device 110 and server 130 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, performed by at least one processor, for text-to-video generation, the method comprising:
receiving a text input;
generating a representation frame based on text embeddings of the text input;
generating a set of frames based on the representation frame and a first frame rate;
interpolating the set of frames based on a second frame rate;
generating a first video based on the interpolated set of frames;
increasing a resolution of the first video based on spatiotemporal information to generate a second video; and
generating an output video by increasing a resolution of the second video based on spatial information.

2. The computer-implemented method of claim 1, wherein the set of frames are combined to generate a low-resolution video.

3. The computer-implemented method of claim 1, wherein the second frame rate is greater than the first frame rate.

4. The computer-implemented method of claim 1, wherein the representation frame is generated using a text-to-image model trained on text-image pair datasets.

5. The computer-implemented method of claim 1, wherein the resolution of the second video is increased on a frame-by-frame basis.

6. The computer-implemented method of claim 1, wherein interpolating the set of frames further comprises:
identifying specific frames from the set of frames based on at least one of a preset number of frames and a position of the frames; and
generating additional frames based on the specific frames using an interpolation model to interpolate the specific frames.

7. The computer-implemented method of claim 1, wherein the second video is generated based on a first super-resolution model and the output video is generated based on a second super-resolution model, the first super-resolution model is fine-tuned on unlabeled video data, and the second super-resolution model applies a fixed noise to each frame in the second video.

8. The computer-implemented method of claim 7, wherein the first super-resolution model includes spatiotemporal convolution and attention layers, wherein a temporal convolution layer is stacked on each spatial convolution layer, and a temporal attention layer is stacked on each spatial attention layer.

9. The computer-implemented method of claim 8, further comprising:
initializing a temporal projection of the temporal attention layer to zero; and
initializing the temporal convolution layer as an identify function.

10. A system for text-to-video generation, the system comprising:
one or more processors; and
a memory storing instructions which, when executed by the one or more processors, cause the system to:
receive a text input;
generate a representation frame based on text embeddings of the text input;
generate a set of frames based on the representation frame and a first frame rate;
interpolate the set of frames based on a second frame rate;
generate a first video based on the interpolated set of frames;
increase a resolution of the first video based on spatiotemporal information using a first super-resolution model to generate a second video; and
generate an output video by increasing a resolution of the second video based on spatial information using a second super-resolution model.

11. The system of claim 10, further comprising generating a low-resolution video based on the set of frames.

12. The system of claim 10, wherein the second frame rate is greater than the first frame rate.

13. The system of claim 10, wherein the representation frame is generated using a text-to-image model trained on text-image pair datasets.

14. The system of claim 10, wherein the first super-resolution model is fine-tuned over unlabeled video data.

15. The system of claim 10, wherein the resolution of the second video is increased on a frame-by-frame basis.

16. The system of claim 10, wherein the one or more processors further execute instructions to:
identify specific frames from the set of frames based on at least one of a preset number of frames and a position of the frames; and
generate additional frames based on the specific frames using an interpolation model to interpolate the specific frames.

17. The system of claim 10, wherein the second super-resolution model applies a fixed noise to each frame in the second video.

18. The system of claim 10, wherein the first super-resolution model includes spatiotemporal convolution and attention layers, wherein a temporal convolution layer is stacked on each spatial convolution layer, and a temporal attention layer is stacked on each spatial attention layer.

19. The system of claim 18, wherein the one or more processors further execute instructions to:
initialize a temporal projection of the temporal attention layer to zero; and
initialize the temporal convolution layer as an identity function.

20. A non-transient computer-readable storage medium having instructions embodied thereon, the instructions being executable by one or more processors to perform a method for text-to-video generation and cause the one or more processors to:
receive a text input;
generate a representation frame based on text embeddings of the text input;
decoding a set of frames conditioned on the representation frame and a frame rate;
interpolate the set of frames based on a second frame rate;
generate a first video based on the interpolated set of frames;
increase a resolution of the first video based on spatiotemporal information using a first super-resolution model to generate a second video; and
increase a resolution of the second video based on spatial information using a second super-resolution model to generate an output video.
